(19) United States
(12) Patent Application Publication
(10) Pub. No.: US 2026/0233716 A1
(43) Pub. Date: Aug. 13, 2026

(54) METHOD FOR ELECTRICALLY CONTROLLING A PARKING BRAKE WITH ESTIMATION OF COOLING

(71) Applicants: ASTEMO France, Drancy (FR); ASTEMO Heilbroon GmbH, HEILBRONN (DE)

(72) Inventors: Julien SASSO, CHAMPS SUR MAARNE (FR); Weiqiao WANG, PARIS (FR); Alex PATRAO CARQUEIJO, PANTIN (FR); Maxime DEMANDRE, STUTTGART (DE)

(21) Appl. No.: 19/153,419

(22) PCT Filed: Feb. 1, 2024
(86) PCT No.: PCT/EP2024/052475

§ 371 Date: Aug. 4, 2025

(30) Foreign Application Priority Data
Feb. 8, 2023 (FR) FR2301186

(51) Int. Cl. B60T 8/172; B60T 8/171; B60T 8/174; B60T 13/74; F16D 66/00

(52) U.S. Cl. CPC B60T 8/172; B60T 8/171; B60T 8/174; F16D 66/00; B60T 13/746; B60T 2210/20; B60T 2210/32; B60T 2250/02; F16D 2066/001

(57) ABSTRACT

A method for electrically controlling a parking brake for a motor vehicle, the brake including at least one friction element connected to an electromechanical actuator capable of moving the friction element towards a braking member. The method includes defining a clamping force for immobilising the vehicle, estimating a temperature variation of the braking member from a convective heat transfer model, ignoring conductive and radiative heat transfer phenomena, defining, from the estimation of the temperature variation, a correction of a clamping to be performed in order to preserve the defined clamping force, and applying the clamping force with correction of the clamping via the actuator.

### FIELD OF THE INVENTION

The invention relates to a method for electrically controlling a parking brake for a motor vehicle.

### BACKGROUND

Disc and drum type brakes are known in the prior art. A brake generally comprises friction means connected to an actuation member, also called an actuator, capable of moving the friction means towards a braking member secured to a vehicle wheel. The objective is to place the friction means, for example brake linings or pads, in contact with the braking member to brake the vehicle by friction or to move them away from the braking member in order to stop braking. When the braking system is a disc brake, the braking member consists of a disc which rotates with the wheel. In case of a drum brake, the braking member consists of a drum which rotates with the wheel.

A given brake may comprise several actuators. For example, it may comprise a hydraulic actuator used for service braking and an electrical actuator for parking and emergency braking. In these latter cases, we also speak of electrically controlled parking brake or electric parking brake. The electric parking brake is increasingly used to replace the manual parking brakes. An electric parking brake is simpler for the vehicle user and is smaller. When a user wants to make the vehicle leave its parking space, they simply press a button to release the electric parking brake, wait, where applicable, for a signal indicating that the electric parking brake has in fact been released, then accelerate.

However, the use of a brake heats the braking member, the disc when the brake is a disc brake, or the drum when the drum is a drum brake.

When a parking brake clamping strategy is defined, this heating must be taken into account, since once parked, the braking member will cool down, and this cooling will clamp the brake less tightly or more tightly. For example, when the disc cools down, its expansion decreases, and therefore the contact with the friction means (pad or shoe) is affected, to the extent of reducing the clamping force. The reduced clamping force may then cause the vehicle to move.

Thus, it is essential to estimate the cooling of the braking member to define an effective clamping force strategy.

It is known to estimate the cooling of the braking member using models that take into account three heat transfer phenomena: convection, conduction and radiation.

Numerous parameters are required to estimate these three phenomena. These parameters can only be determined by tests on vehicles. The following steps must therefore be carried out:
implementing equations with generic parameters;
executing tests on different road conditions with a temperature sensor;
executing a program (Matlab® script for example) to find the best parameters in order to obtain the least error between the estimation and the actual temperature;
implementing new parameters in the software equations;
executing new tests on different road conditions to validate the temperature estimation.

This type of method therefore involves managing abstract parameters, numerous parameters depending on the type of vehicle, and numerous expensive tests. This makes the estimation expensive, especially in terms of the time taken, and relatively inaccurate in practice, which may lead to an overestimation of the clamping that could reduce the brake lifetime, or to an underestimation that could cause an unwanted movement of the vehicle. The maximum temperature estimation error is taken into account in the clamping strategy: choosing the clamping strategy corresponding to a temperature equal to an estimation of the temperature to which a maximum temperature estimation error is added.

### SUMMARY

The invention aims in particular to solve this problem, by proposing a method for electrically controlling a parking brake for a motor vehicle, from an estimation of the cooling of the parking member based on a cooling model ignoring the conductive and radiative phenomena and using only a convective heat transfer model.

The invention therefore relates to a method for electrically controlling a parking brake for a motor vehicle, the brake comprising at least one friction means (pad/brake shoe lining) connected to an electromechanical actuator capable of moving the friction means towards a braking member (disc/drum) to brake, wherein the following steps are carried out:
defining a brake clamping force for immobilising the vehicle;
estimating a temperature variation of the braking member from a convective heat transfer model, ignoring conductive and radiative heat transfer phenomena;
defining, from the estimation of the temperature variation, a correction of a clamping to be performed in order to preserve the defined clamping force;
applying the clamping force with correction of the clamping via the actuator.

Such a convective heat transfer model comprises few parameters, and these parameters mainly depend on the mechanical characteristics of the brakes, and are therefore perfectly known. There is therefore no need to calibrate the parameters. Such a model makes the estimation of the cooling, and therefore of the actual temperature of the braking member, more accurate.

In addition, since this estimation of the cooling is reliable, the vehicle ECU can be switched off more rapidly. The ECU defines a first clamping force according to the slope, then adjusts the clamping/unclamping according to the temperature. In other words, the clamping strategy will be adapted to the actual temperature and it will therefore be possible to avoid oversizing the brake. In addition, it will be possible to reduce the time during which the ECU remains switched on after clamping, since in this case reclamping is not required.

According to other optional characteristics of the method, taken alone or in combination:
the convective heat transfer model comprises the following parameters:
   h: convective heat transfer coefficient of air;
   m: mass of the braking member;
   cₚ: heat capacity of the braking member material;
   Aₛ: contact area between the air and the braking member;
the heat transfer model is written:

$${dT}_{conv} = \frac{h ( v ) {A}_{s}}{m {c}_{p}} ( {T}_{disc} - {T}_{amb} )$$

where dT_{conv} is the temperature variation due to the convective heat transfer phenomenon, T_{disc} is the temperature of the braking member, T_{amb} is the air temperature at the contact area between the air and the braking member, and v is the air speed at the contact area between the air and the braking member;
the convective heat transfer coefficient h is determined using a model, such as the Jürges model;
the mass variation of the braking member over time is taken into account in the convective heat transfer model;
the brake clamping force is defined according to the slope on which the vehicle is resting and the mass of the vehicle;
the clamping correction is carried out by reducing the clamping;
the clamping correction is carried out by increasing the clamping;
the brake is a drum brake, the braking member is a drum, the friction member is a shoe with lining;
the brake is a disc brake, the braking member is a disc, the friction member is a brake pad.

The invention also relates to a motor vehicle comprising an electronic control unit configured to implement the method according to the invention.

### BRIEF DESCRIPTION OF THE FIGURES

It will be easier to understand the invention on reading the description below, given as an example and referring to the attached drawings, on which:

FIG. 1 is a diagrammatic representation of the steps of an example of an electrical control method according to the invention;

FIG. 2 shows the actual change in the temperature of a disc over time, as well as two estimation curves with two different models.

### DETAILED DESCRIPTION

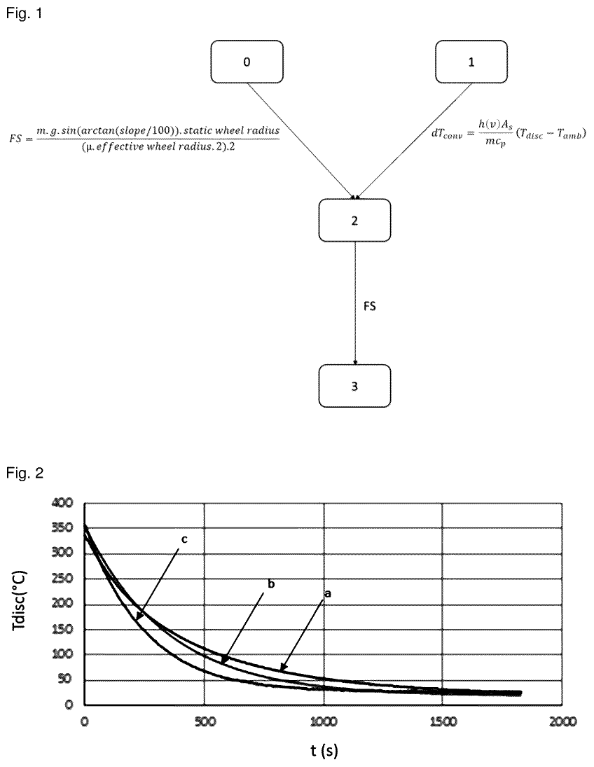

FIG. 1 is a diagrammatic representation of the steps of an example of a method for electrically controlling a parking brake for a motor vehicle according to the invention.

The parking brake comprises at least one friction means connected to an electromechanical actuator capable of moving the friction means towards a braking member to brake.

In a first embodiment variant, the brake is a drum brake, the braking member being a drum, and the friction member being a shoe with lining.

In a second embodiment variant, the brake is also a disc brake, the braking member being a disc, and the friction member being a brake pad.

### The Method Comprises the Following Steps:

defining a brake clamping force FS (step 0) for immobilising the vehicle;
estimating (step 1) a temperature variation of the braking member (heating and cooling) from a convective heat transfer model, ignoring conductive and radiative heat transfer phenomena;
defining (step 2), from the above estimation of the temperature variation, a correction of a clamping to be performed in order to preserve the defined brake clamping force FS;
applying (step 3) the brake clamping force FS with correction of the clamping via the actuator.

In particular, according to the method, a brake clamping force FS is defined according to the slope on which the vehicle is resting and the mass of the vehicle (step 0). This clamping force is determined by applying the following equation:

$$FS = \frac{m \cdot g \cdot sin ( arctan ( slope / 100 ) ) \cdot static wheel radius}{( μ \cdot effective wheel radius \cdot 2 ) \cdot 2}$$

### Where:

m: mass of the vehicle;
g: gravitational constant;
μ: heat loss;
slope: road slope;
static wheel radius: wheel radius; and
effective wheel radius: point where the force is applied (centre of the piston which is at the centre of the wheel).

A temperature variation of the braking member is then estimated from a convective heat transfer model, ignoring conductive and radiative heat transfer phenomena (step 1).

By estimating this temperature variation of the braking member, which results from heating and cooling over time (in actual fact cooling during immobilisation through the use of a parking brake), it is possible to determine the change in the clamping force.

For example, when the brake is a disc brake, a decrease in the temperature of the braking member decreases the expansion of the braking member and therefore increases the distance between the pads and the disc. The clamping force will therefore decrease. The opposite phenomenon is observed for a drum brake, in which the decrease in the expansion decreases the distance between the drum and the shoes, and therefore increases the clamping force. In both cases, the value of the clamping force in real time moves away from the value of the clamping force FS defined beforehand.

After estimating the braking temperature variation, this estimation is used to define a correction of a clamping to be performed in order to preserve the defined clamping force (step 2). As explained above, the temperature variation results in a variation in the value of the clamping force which moves away from the value of the clamping force FS. Quantifying the temperature variation makes it possible to quantify the braking force variation, and therefore to estimate the clamping correction required to return to the clamping force FS.

For example, when the brake is a disc brake, cooling of the disc is estimated. The clamping correction corresponds to an increase in the clamping (of the pads on the disc) to compensate for the increased distance (by decreasing the expansion) of the disc from the pads and therefore return to the clamping force defined initially.

When the brake is a drum brake, cooling of the drum is estimated. The clamping correction corresponds to a decrease in the clamping (of the shoes on the drum) to compensate for the decreased distance (by decreasing the expansion) of the drum from the shoes and therefore return to the clamping force defined initially.

Lastly, the clamping force with correction of the clamping is applied via the actuator (step 3). We therefore obtain optimum immobilisation of the vehicle by applying the clamping force FS, but the latter is obtained by applying a clamping different from that which would have been applied without estimating the temperature variation, and which would not have made it possible to obtain the clamping force FS, but a clamping force greater or smaller than the latter, depending in particular on the type of braking member.

The convective heat transfer model used in step 1 comprises the following parameters:
h: convective heat transfer coefficient of air;
m: mass of the braking member;
cₚ: heat capacity of the braking member material;
Aₛ: contact area between the air and the braking member.

### According to a Preferred Embodiment, the Heat Transfer Model is Written:

$${dT}_{conv} = \frac{h ( v ) {A}_{s}}{m {c}_{p}} ( {T}_{disc} - {T}_{amb} )$$

### Where:

dT_{conv}: temperature variation due to the convective heat transfer phenomenon;
T_{disc}: temperature of the braking member;
T_{amb}: air temperature at the contact area between the air and the braking member; and
v: air speed at the contact area between the air and the braking member.

Parameters v and T_{amb} are obtained using sensors, and their values are therefore obtained immediately.

Parameter T_{disc} corresponds to an estimation of the temperature of the braking member (sum of the cooling and the heating).

Parameters m, cₚ and Aₛ are mechanical characteristics, and are therefore known.

For example, the following table indicates characteristics of a disc for three brake types.

TABLE 1

| | Type 1 | Type 2 | Type 3 |
|---|---|---|---|
| Diameter (m) | 0.295 | 0.295 | 0.33 |
| Thickness (m) | 0.011 | 0.012 | 0.022 |
| Area (m²) | 0.0683 | 0.0683 | 0.0855 |
| Mass (kg) | 5.9 | 7.39 | 5.08 |
| Material | Cast iron | Cast iron | Aluminium |
| Cₚ (J kg⁻¹K⁻¹) | 450 | 450 | 900 |

Parameter h, the convective heat transfer coefficient of air, must be estimated according to the air speed v at the contact area between the air and the braking member. According to a particular embodiment, a Jürges model is used:

$$If v \leq 5 m / s then : h = 4 \times v + 5.6$$

$$If v > 5 m / s then : h = 7.1 \times v \hat{} ( 0.78 )$$

Advantageously therefore, the temperature variation of the braking member can be estimated easily, immediately and accurately, as shown on FIG. 2. This figure shows the change in temperature (° C.) of a disc over time(s). Cooling can therefore be observed. FIG. 2 shows three curves:
a. estimation by a heat transfer model taking into account the convective, conductive and radiative heat transfers;
b. estimation by a heat transfer model according to the invention;
c. the actual, measured temperature.
   We See that:
the average difference between the estimated curve and the real curve is 21.39° C. for curve a, and just 14.15° C. for curve b;
the maximum difference between the estimated curve and the real curve is 46.65° C. for curve a, and just 36.7° C. for curve b.

According to a particular embodiment, the mass variation of the braking member over time is taken into account in the convective heat transfer model. Over time in fact, the use of brakes causes wear, of the braking member in particular: due to friction and corrosion, it loses material and therefore its mass decreases.

In the convective heat transfer model, parameter m therefore becomes a parameter which depends on time: m (t). This parameter can then be evaluated, as for parameter h, by a disc wear predictive model.

The invention also relates to a motor vehicle comprising an electronic control unit configured to implement the method according to the invention.

1. A method for electrically controlling a parking brake for a motor vehicle, the brake comprising at least one friction means connected to an electromechanical actuator capable of moving the friction means towards a braking member to brake, the method comprising steps of:
defining a clamping force for immobilising the vehicle without applying the clamping force;
estimating a temperature variation of the braking member from a convective heat transfer model, ignoring conductive and radiative heat transfer phenomena;
defining, from the estimation of the temperature variation, a correction of a clamping to be performed in order to preserve the defined clamping force;
applying a first clamping force with correction of the clamping via the actuator.

2. The method according to claim 1, wherein the convective heat transfer model comprises the following parameters:
h: convective heat transfer coefficient of air;
m: mass of the braking member;
cₚ: heat capacity of a braking member material; and
Aₛ: contact area between the air and the braking member.

3. The method according to claim 2, wherein the heat transfer model is written:
$${dT}_{conv} = \frac{h ( v ) {A}_{s}}{m {c}_{p}} ( {T}_{disc} - {T}_{amb} )$$
where dT_{conv} is the temperature variation due to a convective heat transfer phenomenon, T_{disc} is the temperature of the braking member, T_{amb} is an air temperature at the contact area between the air and the braking member, and v is an air speed at the contact area between the air and the braking member.

4. The method according to claim 2, wherein the convective heat transfer coefficient h is determined using a Jürges model.

5. The method according to claim 4, wherein a mass variation of the braking member over time is taken into account in the convective heat transfer model.

6. The method according to claim 1, wherein a brake clamping force is defined according to a slope on which the vehicle is resting and a mass of the vehicle.

7. The method according to claim 1, wherein the clamping correction is carried out by reducing the clamping.

8. The method according to claim 1, wherein the clamping correction is carried out by increasing the clamping.

9. The method according to claim 1, wherein the brake is a drum brake, the braking member is a drum, and the friction member is a shoe with lining.

10. The method according to claim 1, wherein the brake is a disc brake, the braking member is a disc, the friction member is a brake pad.

11. A motor vehicle comprising an electronic control unit configured to implement the method according to claim 1.

12. The method according to claim 2, wherein the convective heat transfer coefficient h is determined using a Jürges model.

13. The method according to claim 2, wherein a mass variation of the braking member over time is taken into account in the convective heat transfer model.
